(19) United States
(12) Patent Application Publication
(10) Pub. No.: US 2018/0129498 A1
(43) Pub. Date: May 10, 2018

(54) MICRO-OP FUSION FOR NON-ADJACENT INSTRUCTIONS

(71) Applicant: Centipede Semi Ltd., Netanya (IL)

(72) Inventors: Nadav LEVISON, Lev HaSharon (IL); Noam Mizrahi, Hod-HaSharon (IL); Jonathan Friedmann, Even-Yehuda (IL)

(21) Appl. No.: 15/690,560

(22) Filed: Aug. 30, 2017

Related U.S. Application Data
(60) Provisional application No. 62/418,200, filed on Nov. 6, 2016.

(51) Int. Cl. G06F 9/30; G06F 9/38

(52) U.S. Cl. CPC G06F 9/30007; G06F 9/3812; G06F 9/30181; G06F 9/3017

(57) ABSTRACT

Method(s) for up/down fusion and/or pseudo-fusion of micro-operations are performed in a hardware processor configured to execute program code. A mergeable pair of micro-operations is identified in a sequence of micro-operations of the program code. The pair of micro-operations includes a first micro-operation for performing a first function and a non-consecutive second micro-operation for performing a second function. The first micro-operation precedes the second micro-operation in the sequence of micro-operations being processed. The first micro-operation is merged into the second micro-operation to create a third micro-operation which performs both the first function and the second function. In up/down fusion the third micro-operation is dispatched instead of the first micro-operation or instead of the second micro-operation, based on whether fuse-up or fuse-down is performed. In pseudo-fusion the first micro-operation is retained in the sequence of micro-operations and the second micro-operation is replaced with the third micro-operation.

### RELATED APPLICATIONS

This application claims the benefit of priority under 35 USC § 119(e) of U.S. Provisional Patent Application No. 62/418,200, filed on Nov. 6, 2016. The contents of the above application are all incorporated by reference as if fully set forth herein in their entirety.

### FIELD AND BACKGROUND OF THE INVENTION

The present invention, in some embodiments thereof, relates to an out of order processor and, more particularly, but not exclusively, to an out of order processor with instruction fusion.

One possible way to improve performance of an out of order (OOO) processor is to merge two (or more) consecutive instructions in the program code into a single instruction which performs the function of the consecutive instructions. Consecutive fusion enables executing the two instructions in a single cycle, in order to improve performance. Furthermore, the instruction merge may save a place in the renamer, the re-order buffer (ROB) of the processor and its schedulers. It also may benefit the execution load by removing one of the execution operations. It may also save the allocation of a physical register. Finally, it may also reduce dependency latency and bottleneck after release of dependency when multiple instructions are dependent on the resolved destination.

For example, the instruction “cmp x1,x2” (which compares the values of x1 and x2) and the instruction “beq xxx” (which branches if x1 and x2 were equal) may be merged into a single instruction which performs both the compare and make branch resolution functions. This instruction merge enables resolving the branch a cycle earlier than it would have been resolved if the instructions were not merged. Furthermore, the instruction merge may save a place in the ROB of the processor and its schedulers.

Another example is merging instruction “eor x1,x1,x2” with instruction “and x1,x1,0xffcc”. This results in the merged instruction “and x1, {eor x1,x2}, 0xffcc”.

Example 1 shows yet another example of consecutive micro-op fusion:

Original code:
orr w5, w0, w6
and w5, w5, #0x1

The merged instruction is:
and w5, orr(w0,w6), #0x1
   In the original code, the two instructions must execute one after another while in the merged instruction both functions may be performed in one cycle. More complex operations may take place in two cycles instead of three (e.g. complex ALU+fusion).

When fusion is performed, the processor should include at least one execution unit capable of executing a merged instruction.

Typically, consecutive micro-op fusion is handled in the decoder/renamer. The decoder receives a stream of instructions according to the program order and translates them into micro-ops. If two adjacent instructions/micro-ops which the decoder/renamer processes in a specific cycle are candidates for fusion then the decoder replaces the instructions with a merged micro-op.

U.S. Pat. No. 9,292,291 by Gschwind presents a computer system for optimizing instructions which is configured to identify two or more machine instructions as being eligible for optimization, to merge the two or more machine instructions into a single optimized internal instruction that is configured to perform functions of the two or more machine instructions, and to execute the single optimized internal instruction to perform the functions of the two or more machine instructions.

Additional background art includes
[1] U.S. Pat. No. 6,675,376 by Ronen et al.;
[2] U.S. Pat. No. 8,843,729 by Parks; and
[3] Agner Fog. Technical University of Denmark, “The microarchitecture of Intel, AMD and VIA CPUs An optimization guide for assembly programmers and compiler makers”, Technical University of Denmark., 2016-12-01.

### SUMMARY OF THE INVENTION

Embodiments herein present multiple types of fusion which may be performed on non-consecutive instructions in a sequence of program code being processed by an OOO processor.

One type of fusion presented herein is up/down fusion which merges non-consecutive instructions. The merged instruction either replaces the first instruction in the sequence which participated in the merge (fuse-up) or replaces the last instruction in the sequence which participated in the merge (fuse-down). An analysis of the instruction sequence is performed in order to determine for a given case whether the merged instruction should be fused-up, fused-down or not at all.

Another type of fusion presented herein is pseudo-fusion which merges consecutive and/or non-consecutive instructions. In contrast with other types of fusion, in pseudo-fusion the merged instruction replaces one of the instructions that was merged but the other instructions are not dropped from the instruction sequence.

Optionally, the instructions undergoing processing and fusion are micro-ops.

According to an aspect of some embodiments of the present invention there is provided a method performed in a processor that executes instructions of program code. The method includes identifying, in a sequence of micro-operations of the program code, a mergeable pair of micro-operations. The pair of micro-operations includes a first micro-operation for performing a first function and a non-consecutive second micro-operation for performing a second function. The first micro-operation precedes the second micro-operation in the sequence of micro-operations. The first micro-operation is merged into the second micro-operation to create a third micro-operation that performs both the first function and the second function. During processing of the program code, the third micro-operation is dispatched instead of the second micro-operation or the third micro-operation is dispatched instead of the first micro-operation.

According to some embodiments of the invention, the method further includes dropping the first micro-operation prior to dispatching the third micro-operation instead of the second micro-operation.

According to some embodiments of the invention, the method further includes dropping the second micro-operation prior to dispatching the third micro-operation instead of the first micro-operation.

According to some embodiments of the invention, the method further includes dropping the first micro-operation prior to decoding.

According to some embodiments of the invention, identifying the mergeable pair of micro-operations includes selecting one of fuse-up and fuse down for the dispatching, wherein fuse-up includes the dispatching the third micro-operation instead of the first micro-operation and the fuse-down includes dispatching the third micro-operation instead of the second micro-operation.

According to some embodiments of the invention, the method further includes: monitoring processing of repetitive program code so as to identify the first micro-operation and the second micro-operation as mergeable into the third micro-operation that performs both the first function and the second function; storing information relating to the first micro-operation and/or the second micro-operation;

and, upon a subsequent fetch of the first micro-operation, retrieving the stored information for use during processing of the program code.

According to some embodiments of the invention, merging of the first micro-operation into the second micro-operation to create the third micro-operation is based on the retrieved information.

According to some embodiments of the invention, the method further includes, during the processing of the program code, preventing the dispatching of the third micro-operation and dispatching the sequence of micro-operations in unmerged order.

According to some embodiments of the invention, dispatching the third micro-operation is prevented upon recovery from a mis-speculation on an intermediate micro-operation between the first micro-operation and the second micro-operation.

According to some embodiments of the invention, identifying the mergeable pair of micro-operations includes:

classifying the first micro-operation and the second micro-operation as a potentially-mergeable pair of micro-operations when a destination register of the first micro-operation comprises a source register of the second micro-operation; and

for the potentially-mergeable pair of micro-operations:

confirming the first micro-operation and the second micro-operation as mergeable-down when all destination registers of micro-operations between the first micro-operation and the second micro-operation differ from the source registers of the first micro-operation; and

confirming the first micro-operation and the second micro-operation as mergeable-up all destination registers of micro-operations between the first micro-operation and the second micro-operation differ from the source registers of the second micro-operation.

According to some embodiments of the invention, the method further includes: permitting the dispatching of the third micro-operation instead of the second micro-operation when all destination registers of micro-operations between the first micro-operation and the second micro-operation differ from the source registers of the first micro-operation; permitting the dispatching of the third micro-operation instead of the first micro-operation when all destination registers of micro-operations between the first micro-operation and the second micro-operation differ from the source registers of the second micro-operation; and selecting one of the permitted dispatchings for the performing during the processing.

According to some embodiments of the invention, when dispatching the third micro-operation instead of the second micro-operation is permitted, the third micro-operation is dispatched instead of the second micro-operation irrespective of the permissibility of dispatching the third micro-operation instead of the first micro-operation.

According to some embodiments of the invention, when dispatching of third micro-operation instead of the first micro-operation is permitted, the third micro-operation is dispatched instead of the first micro-operation irrespective of the permissibility of dispatching the third micro-operation instead of the second micro-operation.

According to some embodiments of the invention, the method further includes, when an interrupt is detected during processing of a series of micro-operations comprising the merged micro-operation, flushing all micro-operations in the series preceding the interrupt and reprocessing with the first micro-operation and second micro-operation unmerged.

According to some embodiments of the invention, the method further includes: flushing to the first micro-operation when a flush point occurs between the first micro-operation and the second micro-operation.

According to some embodiments of the invention, the method further includes: detecting a mis-speculation event on a micro-operation between the first micro-operation and the second micro-operation and, in response to the detecting the mis-speculation event, flushing micro-operations including and subsequent to the first micro-operation.

According to some embodiments of the invention, the method further includes: detecting a mis-speculation event on a micro-operation between the first micro-operation and the second micro-operation and, in response to the detecting the mis-speculation event, flushing micro-operations subsequent to the second micro-operation.

According to some embodiments of the invention, the first micro-operation and the second micro-operation are fetched in different cycles.

According to some embodiments of the invention, the first micro-operation and the second micro-operation are decoded in different cycles.

According to some embodiments of the invention, the method further includes bundling the sequence of micro-operations into a single bundle and committing the bundle as a block.

According to an aspect of some embodiments of the present invention there is provided a hardware-implemented pipeline configured to process program code and an up-down selection unit. The up-down selection unit associated is configured to:

identify, in a sequence of micro-operations of the program code, a mergeable pair of micro-operations. The pair of micro-operations includes a first micro-operation for performing a first function and a non-consecutive second micro-operation for performing a second function;

merge the first micro-operation into the second micro-operation to create a third micro-operation that performs both the first function and the second function;

and select whether to dispatch the third micro-operation instead of the second micro-operation or to dispatch the third micro-operation instead of the first micro-operation.

The sequence of micro-operations is processed in accordance with the selected dispatching.

According to some embodiments of the invention, the up-down selection unit is further configured to select dispatching the sequence of micro-operations in unmerged order.

According to some embodiments of the invention, dispatching the sequence of micro-operations in unmerged order is selected upon recovery from a mis-speculation on an intermediate micro-operation between the first micro-operation and the second micro-operation.

According to some embodiments of the invention, the up-down selection unit is further configured to:

monitor processing of repetitive program code so as to identify the first micro-operation and the second micro-operation as mergeable into the third micro-operation for performing both the first function and the second function;

store information relating to at least one of the first micro-operation and the second micro-operation; and

upon a subsequent fetch of the first micro-operation, retrieve the stored information for use during the processing of the program code.

According to an aspect of some embodiments of the present invention there is provided a method performed in a processor that executes instructions of program code. The method includes identifying, in a sequence of micro-operations of the program code, a mergeable pair of micro-operations. The pair of micro-operations includes a first micro-operation for performing a first function and a second micro-operation for performing a second function. The first micro-operation precedes the second micro-operation in the sequence of micro-operations. The first micro-operation is merged into the second micro-operation to create a third micro-operation that performs both the first function and the second function. In the sequence of micro-operations, the first micro-operation is retained in the sequence of micro-operations and the second micro-operation is replaced with the third micro-operation.

According to some embodiments of the invention, the method further includes, after replacing the second micro-operation with the third micro-operation, dispatching the sequence of micro-operations.

According to some embodiments of the invention, the method further includes, when the first micro-operation and the second micro-operation are fetched, preventing the merging of the first micro-operation and the second micro-operation and dispatching the sequence of micro-operations in unmerged order.

According to some embodiments of the invention, the method further includes:

monitoring processing of the program code so as to identify the first micro-operation and the second micro-operation as mergeable into the third micro-operation for performing both the first function and the second function;

storing information indicating the first micro-operation and the second micro-operation as mergeable; and

upon a subsequent fetch of the first micro-operation, retrieving the stored information for use during subsequent processing of the program code.

According to some embodiments of the invention, the first micro-operation and the second micro-operation are non-consecutive in the sequence and micro-operations between the first micro-operation and the second micro-operation are retained in order in the sequence.

According to some embodiments of the invention, the method further includes, when an interrupt is detected during processing of a series of micro-operations which includes the retained first micro-operation, the third micro-operation and intermediate micro-operations between the third micro-operation and the retained first micro-operation, flushing all micro-operations in the series preceding the interrupt and reprocessing with the second micro-operation unmerged.

According to some embodiments of the invention, for a non-consecutive first micro-operation and the second micro-operation the method further includes:

detecting a mis-speculation event on an intermediate micro-operation between the third micro-operation and the retained first micro-operation; and

in response to the detecting the mis-speculation event, triggering recovery from the mis-speculation event.

According to some embodiments of the invention, identifying a mergeable pair of micro-operations includes classifying the first micro-operation and the second micro-operation as a potentially-mergeable pair of micro-operations when a destination register of the first micro-operation is a source register of the second micro-operation.

According to some embodiments of the invention, identifying a mergeable pair of micro-operations further includes confirming the potentially-mergeable pair of micro-operations as mergeable when one of:

the first micro-operation and the second micro-operation are consecutive in the sequence; and

the first micro-operation and the second micro-operation are non-consecutive in the sequence and all destination registers of micro-operations between the first micro-operation and the second micro-operation differ from the source registers of the first micro-operation.

According to an aspect of some embodiments of the present invention there is provided a hardware-implemented pipeline configured to process program code and a pseudo-fusion unit. The pseudo-fusion unit associated is configured to:

identify, in a sequence of micro-operations processed in the pipeline, a mergeable pair of micro-operations. The pair of micro-operations includes a first micro-operation for performing a first function and a second micro-operation for performing a second function. The first micro-operation precedes the second micro-operation in the sequence of micro-operations.

merge the first micro-operation into the second micro-operation to create a third micro-operation that performs both the first function and the second function;

and in the sequence of micro-operations, retain the first micro-operation and replace the second micro-operation with the third micro-operation.

According to some embodiments of the invention, identifying a mergeable pair of micro-operations includes detecting when a destination register of the first micro-operation is a source register of the second micro-operation.

According to some embodiments of the invention, the first micro-operation and the second micro-operation are unmergeable when a destination register of a micro-operation between the first micro-operation and the second micro-operation is a source register of the first micro-operation.

According to some embodiments of the invention, the pseudo-fusion unit is further configured to:

monitor processing of repetitive program code to detect that the first micro-operation and the second micro-operation are mergeable into the third micro-operation for performing both the first function and the second function;

store information relating to at least one of the first micro-operation and the second micro-operation; and

upon a subsequent fetch of the first micro-operation, retrieve the stored information for use during subsequent processing of the program code.

According to some embodiments of the invention, the pseudo-fusion unit is further configured to dispatch the sequence after replacing the second micro-operation with the third micro-operation.

According to some embodiments of the invention, the pseudo-fusion unit is further configured to prevent merging of the first micro-operation and the second micro-operation.

According to some embodiments of the invention, the first micro-operation and the second micro-operation are non-consecutive in the sequence of micro-operations, and micro-operations between the first micro-operation and the second micro-operation are retained in order in the sequence.

According to some embodiments of the invention, the processor further includes an execution unit configured to execute the third micro-operation in a single cycle.

According to some embodiments of the invention, the processor further includes a memory storing the sequence of micro-operations in an issue queue, wherein the third micro-operation is stored in a single slot of the issue queue.

According to some embodiments of the invention, the processor is further configured to issue the first micro-operation and the third micro-operation concurrently for execution.

According to some embodiments of the invention, the pseudo-fusion unit is further configured to monitor fetched micro-operations and to detect the first micro-operation and the second micro-operation prior to entry of the second micro-operation into a decoder unit of the processor.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram illustrating the architecture of an out-of-order (OOO) processor, in accordance with exemplary embodiments of the invention;

FIG. 2 is a simplified flowchart of a method for performing up/down fusion, according to embodiments of the invention;

FIG. 3 is a simplified flowchart of a method for identifying mergeable pairs of micro-ops, according to embodiments of the invention;

FIG. 4 is a simplified flowchart for a method of performing pseudo-fusion, according to embodiments of the invention; and

FIG. 5 is a simplified flowchart of a method for collecting and using information about mergeable micro-ops, according to embodiments of the invention.

### DESCRIPTION OF SPECIFIC EMBODIMENTS OF THE INVENTION

The present invention, in some embodiments thereof, relates to an out of order processor and, more particularly, but not exclusively, to an out of order processor with instruction fusion.

Both up/down fusion and pseudo-fusion create a merged micro-op from at least two micro-ops present in the program code.

There are several potential benefits for merging micro-ops. One potential benefit is that the merged micro-op may be executed faster than if the original micro-ops were executed separately. Without fusion, the micro-ops cannot execute concurrently. In up/down fusion, dropping the other micro-ops saves processor resources such as dispatch and issuing slots, scheduler entries and physical register.

Up/down fusion and pseudo-fusion are described in detail below. It is to be understood that up/down fusion and pseudo-fusion are not mutually exclusive.

Optional embodiments include:

i) Only up/down fusion;

ii) Only pseudo-fusion; or

iii) Both up/down fusion and pseudo-fusion.

Additional optional embodiments include conventional fusion along with up/down fusion and/or pseudo-fusion.

For clarity, exemplary embodiments presented herein are described as the fusion of two micro-ops; a first micro-op which performs a first function and a second micro-op which performs a second function are merged to form a third micro-op which performs both functions. The first micro-op precedes the second micro-op in the sequence of fetched micro-ops. As a person of skill in the art will appreciate, embodiments of both up/down fusion and of pseudo-fusion may be performed on more than two micro-ops (where the merged micro-op performs the functions of all the micro-ops that were merged together to form the merged micro-op).

As used herein the term “fusion” means merging two (or more) instructions or micro-ops which are data dependent into a single micro-op which performs the functions of the two or more instructions that were merged.

As used herein the term “instruction” means a code element which is processed through the pipeline. As used herein the term “instruction” includes micro-ops and more complex code which is converted into multiple micro-ops before being issued.

As used herein the term “micro-op” means an instruction which performs basic operations on data stored in one or more registers. It is noted that some embodiments are described herein as relating to merging micro-ops but are readily adaptable by a person of skill in the art into merging instructions at other levels of complexity (such as macro-ops). It is further noted that embodiments described herein as relating to merging instructions are non-limiting as to the level of complexity of the instruction (e.g. the instructions may be micro-ops, macro-ops, etc.).

As used herein the term “micro-op fusion” means fusion which is performed on two (or more) micro-ops to form a single micro-op which performs the functions of all of the micro-ops which were merged.

As used herein the term “fuse-up” means fusion in which the merged instruction replaces the first one of the merged instructions in the instruction stream and the other merged instructions are dropped (i.e. not dispatched).

As used herein the term “fuse-down” means fusion in which the merged instruction replaces the last one of the merged instructions in the instruction stream and the other merged instructions are dropped.

As used herein the term “up/down fusion” means a type of fusion which includes a decision whether to fuse-up or fuse-down.

As used herein the term “non-consecutive instructions” means instructions which have additional instructions fetched between them. It is noted that the terms “fuse-up” and “fuse-down” are distinct from each other only when the first and last instructions being merged are non-consecutive.

As used herein the term “non-consecutive fusion” means fusion which is performed on non-consecutive instructions, with intermediate instructions between the first and last instruction being merged.

As used herein the term “consecutive fusion” means fusion which is performed on consecutive instructions.

As used herein the term “pseudo-fusion” is defined as fusing two (or more) instructions which are data dependent into a single instruction which performs the functions of the two or more instructions that were merged, without dropping the other instructions from the instruction stream. The pseudo-fused instruction replaces the last one of the merged instructions in the instruction stream while the other instructions are left untouched.

As used herein the term “micro-op pseudo-fusion” is defined as pseudo-fusion which is performed on two (or more) micro-ops.

### Conditions for Merging Micro-Ops

In order for two micro-ops to be eligible for merging (denoted herein potentially-mergeable micro-ops) some conditions should be met. These conditions may vary depending on the implementation. Optionally, in order for micro-ops to be potentially-mergeable (for up/down fusion and/or pseudo-fusion) the destination register of the first micro-op is one of the source registers of the second micro-op and the respective destination registers of the first and second micro-ops are the same register.

Optionally, there are additional constraints based on the CPU Implementation including but not limited to:
a) There is an execution unit that can perform the merged micro-op (e.g. in Example 5 below, the ALU is able to perform the merged ORR&ADD operation);
b) The number of unique register sources of the merged micro-op is suitable for the given implementation (e.g. in Example 5 below, the merged micro-op may have two source registers and one immediate field).
   Additional optional factors specific to up/down fusion and pseudo-fusion are presented below.

Optionally, the decision whether two or more micro-ops are potentially-mergeable is based on logical rules which take into account the constraints of the particular implementation. Further optionally, the logic is updatable and may be changed during processing and/or during when the processor is idle.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product, and may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

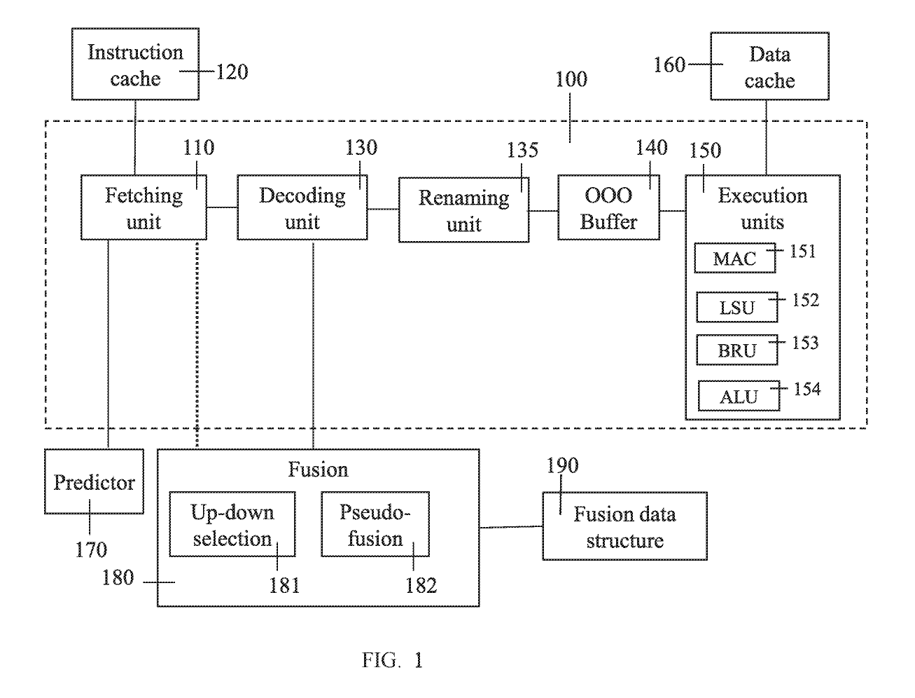

Reference is now made to FIG. 1, which is a simplified block diagram illustrating an architecture of an out-of-order (OOO) processor, in accordance with exemplary embodiments of the invention. The configuration of processor 100 shown in FIG. 1 is an exemplary configuration that is chosen for the sake of conceptual clarity. In alternative embodiments, any other suitable processor configuration may be used. It is further noted, that FIG. 1 illustrates non-limiting embodiment of a single thread pipeline processor. A person of skill in the art will appreciate that embodiments of the invention may be implemented in a multi-thread processor (e.g. with dedicated fusion units per thread and/or a single fusion unit managing multiple threads).

Processor 100 runs software code. Processor 100 includes a single thread that comprises fetching unit 110, decoding unit 130, renaming unit 135 and OOO buffer 140. Fetching unit 110 fetches the program instructions from a memory, e.g., from instruction cache 120 (optionally a multi-level cache). Decoding unit 130 decodes the fetched instructions. The decoded instructions are renamed in renaming unit 135 and are then buffered in OOO buffer 140 for out-of-order execution by execution units 150 (i.e. not necessarily in the order in which they have been fetched by fetching unit 110).

Optionally, at least one of the execution units is capable of executing merged instructions (resulting from embodiments of up/down fusion and/or pseudo-fusion) in a single cycle.

In the present example, execution units 150 comprise Multiply-Accumulate (MAC) unit 151, Load-Store Unit (LSU) 152, Branch execution Unit (BRU) 153 and Arithmetic Logic Unit (ALU) 154. In alternative embodiments, execution units 150 may comprise any other suitable types of execution units (e.g. Floating Point Unit), and/or any other suitable number of execution units of each type.

Optionally, LSU 152 stores data in data cache 160 when executing store instructions and retrieves data from data cache 160 when executing load instructions. Storing data in a data cache reduces memory access latency. Alternately, some or all of the data is not cached and is stored in a dedicated and/or common portion of the processor memory.

In other examples, the processor may be implemented without cache or with a different cache structure, without branch prediction or with trace and/or branch prediction. The processor may comprise additional elements not shown in FIG. 1, such as physical registers. Further alternatively, the disclosed techniques may be carried out with processors having any other suitable microarchitecture.

Processor 100 may be implemented using any suitable hardware, such as using one or more Application-Specific Integrated Circuits (ASICs), Field-Programmable Gate Arrays (FPGAs) or other device types. Additionally or alternatively, certain elements of processor 100 may be implemented using software, or using a combination of hardware and software elements. The instruction and data cache memories may be implemented using any suitable type of memory, such as Random Access Memory (RAM).

Optionally, processor 100 includes predictor 170 which predicts branches and/or traces that are expected to be traversed by the program code during execution, and, based on the predictions, instructs fetching unit 110 which new instructions are to be fetched from memory.

Processor 100 includes and/or has access to one or more memories, which are collectively referred to herein as a memory system. The memory system may be structured and accessed in any way known in the art. In the present example, instruction cache 120, data cache 160 and fusion data structure 190 may be considered to form a memory system. Typically, the memory system will include other components, such as additional memory for storing non-cached instructions and physical registers.

Processor 100 may be programmed in software to carry out the functions described herein. The software may be downloaded to the processor in electronic form, over a network or it may, alternatively or additionally, be provided and/or stored on non-transitory tangible media, such as magnetic, optical, or electronic memory.

Fusion unit 180 implements one or both of up/down fusion and pseudo-fusion in processor 100. For clarity, fusion unit 180 is illustrated in a non-limiting exemplary configuration with separate elements for up/down fusion and pseudo-fusion; up-down selection unit 181 which implements up/down fusion and pseudo-fusion unit 182 which implements pseudo-fusion. However, in other configurations fusion unit 180 may implement only pseudo-fusion or only up/down fusion. In yet another configuration, fusion unit 180 combines the functionality of both up-down selection unit 181 and pseudo-fusion unit 182.

Optionally fusion unit 180 monitors the processing of the program code and stores data which may later be used for merging micro-ops, decision making as to whether the micro-ops should be merged, etc. Optionally, information gathered, generated and/or required by fusion unit 180 is stored in fusion data structure 190. Optionally, fusion data structure 190 is a dedicated memory or cache. Additionally or alternately, some or all of fusion data storage unit 180 is integrated into the processor internal and/or external memory.

Optionally fusion unit 180 performs one or more of:

a) Monitoring instructions fetched by fetch unit 110;

b) Monitoring instructions decoded by decode unit 120;

c) Storing and retrieving fusion data from fusion data structure 190;

d) Analyzing fusion data; and

e) Detecting and/or recovering from mispredictions, exceptions, flushes, etc.

### Up/Down Fusion

In up/down fusion, two or more non-consecutive micro-ops (denoted the unmerged micro-ops) are merged into a single micro-op (denoted the merged micro-op). The merged micro-op performs all the functions of the unmerged micro-ops that were merged together to form the merged micro-op. The micro-ops that were merged together to form the merged micro-op are dropped from the instruction stream, and the merged micro-op is dispatched instead. Consider a series of micro-op which begins at the first micro-op in the merge, includes the micro-ops between the first and last of the unmerged micro-ops (denoted the intermediate micro-ops) and terminates at the last micro-op in the merge. Dispatching the merged micro-op instead of the first micro-op in the series is denoted herein “fuse-up”. Dispatching the merged micro-op instead of the last micro-op in the series is denoted herein “fuse-down”.

Optionally, the intermediate micro-ops are retained in their original order in the instruction sequence. Alternately, some or all of the intermediate micro-ops are themselves merged by up/down fusion and/or pseudo-fusion and/or consecutive fusion.

In consecutive fusion, the micro-ops which are merged together are sequential with no intermediate micro-ops. Therefore, after they are merged the resulting micro-op remains in the same location in the instruction stream that was previously taken up by the two unmerged micro-ops. This is not the case in up/down fusion, in which the unmerged micro-ops are non-consecutive and there are micro-ops between the first and second unmerged micro-op. The merged micro-op may be dispatched instead of the first micro-op or instead of the second micro-op. The sequence of the dispatched micro-ops is different for fuse-up and for fuse-down.

As the instructions are processed and micro-ops undergo merging, a decision is made for each merged micro-op whether it will be fused-up or fused-down. In some cases, the merged micro-op in a given sequence of micro-ops may be fused up and fused down. However, in other cases there is only one option (i.e. fuse-up or fuse-down) that is logically equivalent to the original code.

Optionally, the constraints for fuse-up and fuse-down are:

a) For fuse-up—the source registers of the second micro-op are not used as a destination register in the intermediate micro-ops between the first micro-op and the second micro-op (unless the intermediate micro-ops are merged to prevent this condition, e.g. by fusion or pseudo fusion).

b) For fuse-down—the source registers of the first micro-op are not used as a destination register in the intermediate micro-ops between the first micro-op and the second micro-op (unless the intermediate micro-ops are merged to prevent this condition, e.g. by fusion or pseudo fusion).

Example 2 shows a case where the merged micro-op may fused up or fused down:

Original code:
orr w5, w0, w6
add w10, w10, w10
and w5, w5, #0x1

When fusing-up we get the following code:
and w5, ORR(w0,w6), #0x1
add w10, w10, w10

When fusing-down we get the following code:
add w10, w10, w10
and w5, ORR(w0,w6), #0x1

Example 3 shows a case where only fuse-down is possible:

Original code:
orr w5, w0, #0xf
mul w3, w10, w10
and w5, w5, w3

Fuse-down code:
mul w3, w10, w10
and w5, ORR(w0,#0xf), w3

It is not possible to fuse-up because w3 is written by the ‘mul’ micro-op and is also used by the ‘and’ micro-op. If the ‘and’ micro-op is fused-up, the value of w3 used by the fused micro-op will not be correct.

Example 4 shows a case where only fuse-up is possible:

Original code:
orr w5, w0, #0xf
mul w0, w10, w10
and w5, w5, w3

Fuse-up code:
and w5, ORR(w0,#0xf), w3
mul w0, w10, w10

It is not possible to fuse-down because w0 is written by the ‘mul’ micro-op and it used by the ‘orr’ micro-op. If ‘orr’ micro-op is fused-down, the value of w0 used by the fused micro-op will not be correct.

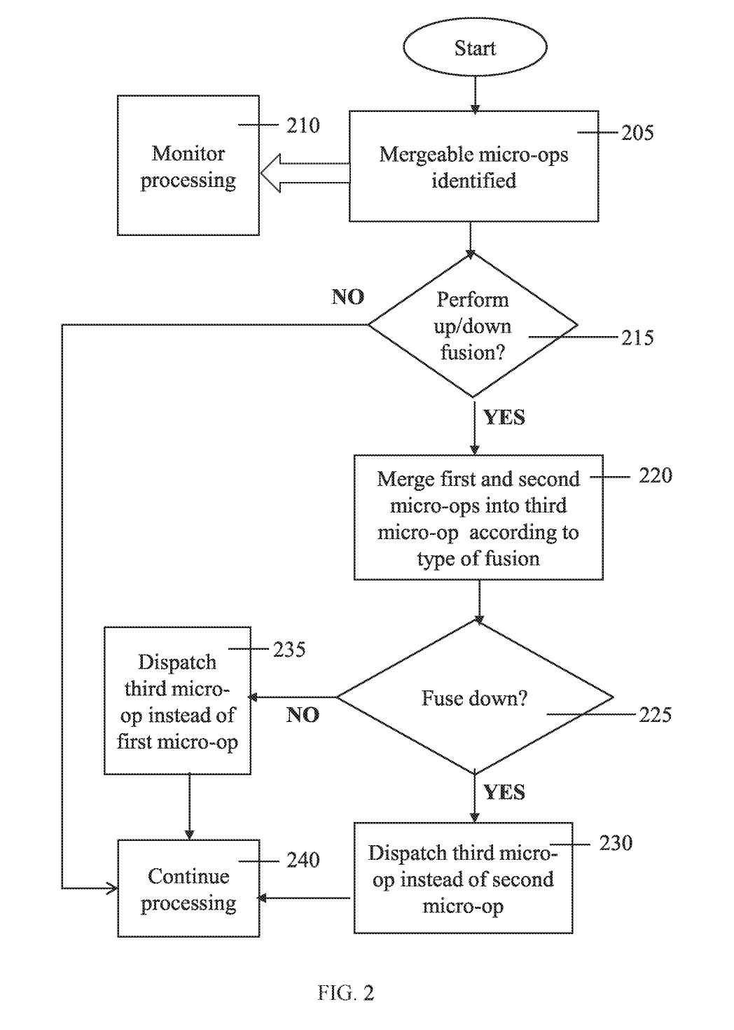

Reference is now made to FIG. 2 which is a simplified flowchart of a method for performing up/down fusion, according to embodiments of the invention. The method is performed by a hardware processor configured to execute program code. Optionally, the program code is stored on a non-transitory computer readable storage medium (e.g. external memory, processor internal memory, instruction cache and/or any other embodiment known in the art).

Optionally, the processor includes up-down selection unit 181, which performs some or all of the method in cooperation with other units of the processor.

In 205 a mergeable pair of micro-operations is identified in a sequence of micro-operations of the program code. The pair of micro-operations includes a first micro-operation for performing a first function and a later non-consecutive second micro-operation for performing a second function. Optionally, the first micro-operation and the second micro-operation are fetched in different cycles.

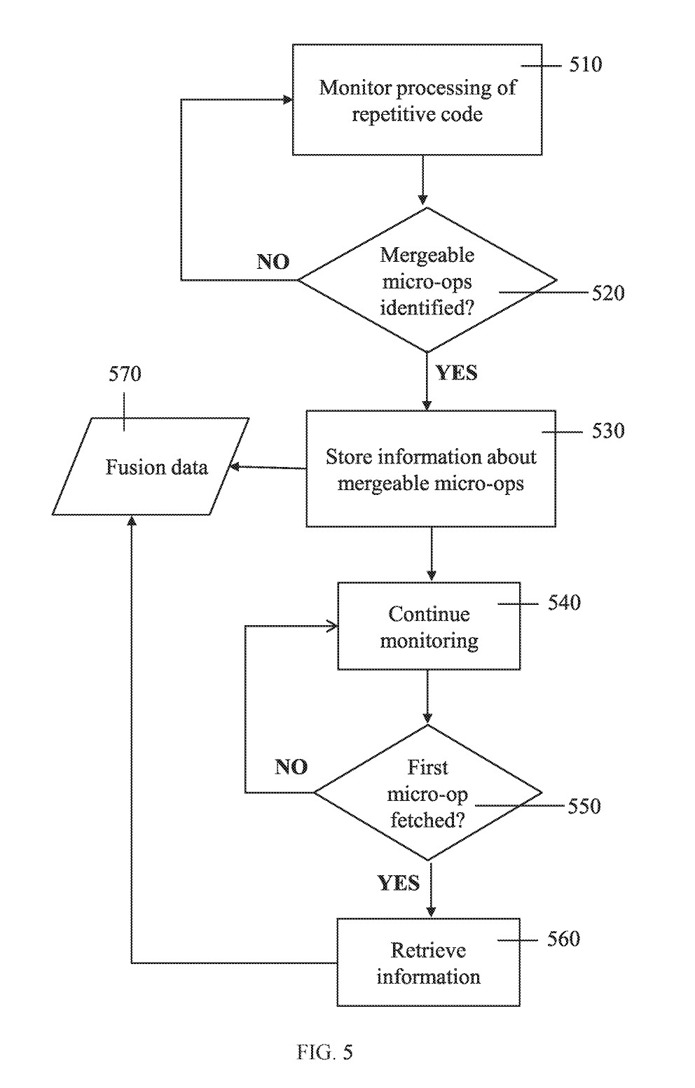

Optionally, in 210 the processing is monitored over time and information is gathered and stored. Further optionally, this information is used to identify mergeable pairs of micro-ops in the instruction sequence. An exemplary embodiment is described for FIG. 5 in which fusion data (which was stored while the processing was being monitored) is retrieved when the first micro-op is fetched. In a second exemplary embodiment, mergeable pairs are identified and the decision to merge is made when the decoder decodes the first and second micro-ops (even if there is no fusion data associated with the first and/or second micro-op).

In 215, the sequence of micro-ops is analyzed, optionally as they are fetched by the decoder. Based on the results of the analysis, a decision is made whether the micro-ops should be merged or if processing should be continued with the original sequence (denoted herein “unmerged order”). Even when a potentially-mergeable pair of micro-ops is identified in 205, analysis of the sequence of micro-operations may lead to a decision not to merge the pair of micro-operations. If the decision is that the micro-ops should be merged, then the type of merge is selected (i.e. fuse-up or fuse-down).

The decision logic whether or not to merge the pair of micro-ops and/or whether the micro-ops should be fused-up or fused-down is optionally based one or more factors including but not limited to:
a) The number of operands for the merged micro-op;
b) The number of destination registers of the merged micro-op;
c) The distance between the first and second micro-ops (e.g. there may be a maximum distance between micro-ops for which merging is permitted);
d) Coherency check (e.g. does a non-merged intermediate micro-op use the destination register of the first micro-op as an operand); and
e) The type(s) of intermediate micro-ops (e.g. a merge might be prevented if the intermediate micro-ops include a branch, load-store or DIV instruction).

Optionally, upon recovery from a flush on an intermediate micro-operation, merging the pair of micro-ops is not permitted.

Based on the type of fusion selected in 215, in 220 the first micro-operation is merged into the second micro-operation to create a third micro-operation which performs the functions of both the first and second micro-ops. Optionally, the micro-ops are merged in the decoder.

In 225 it is determined if fuse-up or fuse-down was selected in 215. If fuse-down was selected, in 230 the third micro-operation is dispatched instead of the second micro-operation and the first micro-operation is dropped from the instruction stream. If fuse-up was selected, in 235 the third micro-operation is dispatched instead of the first micro-operation and the second micro-operation is dropped from the instruction stream. In 240 processing continues.

If merging the micro-ops is not permitted, processing continues in 240 and the sequence of micro-ops is dispatched without merging the two micro-ops.

In some cases, only fuse-up is possible or only fuse-down is possible, in which case there is only one correct decision in 225. However, when both fuse-up and fuse-down are possible, the decision whether to fuse-up or fuse-down will be based other factors.

As a person of skill in the art will appreciate, the decision process of whether to fuse-up or fuse-down may vary in different embodiments of the invention, in accordance with the specific implementation. Typically, fuse-up will improve performance however fuse-down will easier to implement. In fuse-down the dispatch of the merged micro-op is delayed, possibly hurting performance. However, fuse-down may be relatively easy to implement because in fuse-down the first micro-op is dropped and replaced by the second micro-op. Thus, the decoder has the all information it needs in order to construct the merged micro-op. In fuse-up the dispatch of the merged micro-op is advanced, possibly improving performance. However, it may be hard to implement because in fuse-up the first micro-op is replaced and the second micro-op is dropped. Thus the decoder must know what the second micro-op is while processing the first micro-op.

Optionally, during fuse-down the first micro-operation is dropped prior to dispatching the third micro-operation. In alternate embodiments, during fuse-down the first micro-operation is dropped prior to decoding.

Optionally, during fuse-up the second micro-operation is dropped prior to dispatching the third micro-operation. In alternate embodiments, during fuse-up the second micro-operation is dropped prior to decoding.

Optionally, the decision whether to drop a micro-op and/or at what stage it should be dropped are based on information stored in the fusion data.

Optionally, after merging the micro-ops, the sequence of micro-operations including the merged micro-op is bundled into a single bundle and committed as a block. Further optionally, the bundle includes a branch operation.

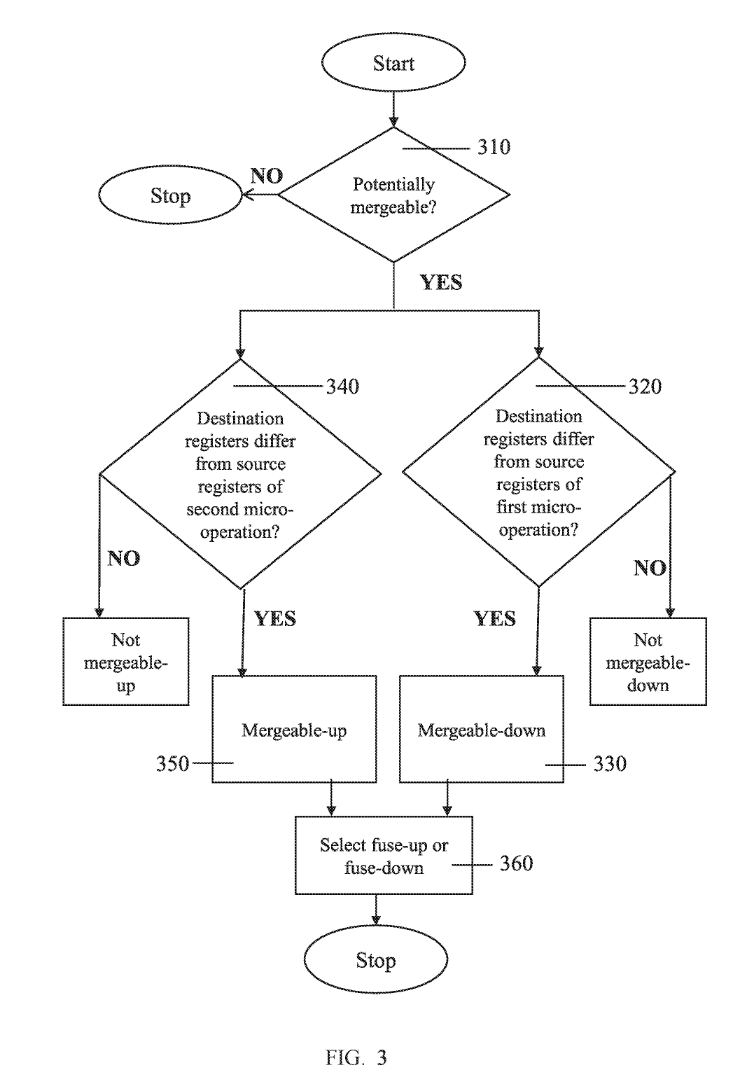

Reference is now made to FIG. 3, which is a simplified flowchart of a method for identifying mergeable pairs of micro-ops, according to embodiments of the invention. FIG. 3 illustrates the case in which a specific pair of micro-ops is being checked to determine if they are eligible for up/down fusion.

In 310, a pair of micro-ops is classified as potentially-mergeable. Optionally, the pair of micro-ops is considered potentially-mergeable when a destination register of the first micro-operation is the same as a source register of the second micro-operation.

If in 320 it is found that the destination registers of all intermediate micro-operations differ from the source registers of the first micro-operation, in 330 the pair of micro-ops is confirmed as being mergeable-down. If not, the pair of micro-ops is not mergeable-down.

Similarly, if in 340 it is found that the destination registers of all intermediate micro-operations differ from the source registers of the second micro-operation, in 350 the pair of micro-ops is confirmed as being mergeable-up (i.e. suitable for fuse-up). If not, the pair of micro-ops is not mergeable-up.

Optionally, in 360 either fuse-up or fuse-down is selected for the pair of micro-operations based on whether they are mergeable-up, mergeable-down or both. If the micro-ops are only mergeable-up, then fuse-up is selected. If the micro-ops are only mergeable-down, then fuse-down is selected. If the micro-ops are both mergeable-up and mergeable-down then either fuse-up or fuse-down may be selected, and the decision whether to fuse-up or fuse-down may be based on logical rules which take into account the constraints of the particular implementation.

Optionally, an indication of whether the pair of micro-operations is mergeable-up, mergeable-down or both is stored as part of the fusion data.

Optionally, in some or all occasions, when the micro-operations are mergeable-up the third micro-operation is dispatched instead of the first micro-operation (i.e. fuse-up) whether or not the micro-ops are mergeable-down. Alternately or additionally, in some or all occasions, when the micro-operations are mergeable-down the third micro-operation is dispatched instead of the second micro-operation (i.e. fuse-down) whether or not the micro-ops are mergeable-up.

### Pseudo-Fusion

In pseudo-fusion, similarly to up/down fusion, multiple micro-ops are merged into a single micro-op which performs the functions of all the micro-ops that were merged. Unlike up/down fusion, in pseudo-fusion the merged micro-op replaces the last micro-op that was merged (e.g. the second micro-op), but the other micro-ops that were merged are not dropped from the sequence. Pseudo-fusion may be performed on non-consecutive instructions and on consecutive instructions.

Optionally, in addition to the general constraints for fusion (e.g. a destination register of the first micro-operation is a source register of the second micro-operation), constraints for pseudo-fusion are:
a) The source registers of the first micro-op are not used as a destination register in intermediate micro-ops (unless the intermediate micro-ops are merged to prevent this condition, e.g. by fusion or pseudo fusion).
b) The destination register of the first micro-op is not used as a destination register in intermediate micro-ops between the first micro-op and the second micro-op.

Example 5 illustrates pseudo-fusion:

Original code:
orr w5, w0, w6
and w9, w5, #0x1

The pseudo fused result is:
orr w5, w0, w6
and w9, orr(w0,w6), #0x1

In the original code, the two micro-ops must execute one after another while in the pseudo-fused version the two micro-ops are independent and may issue concurrently.

In pseudo-fusion the merged micro-op may be executed faster than executing the unmerged micro-ops separately. Additionally, there is no need for special handling when there is a flush in one of the intermediate micro-ops. The architectural state in the flushed micro-op is correct.

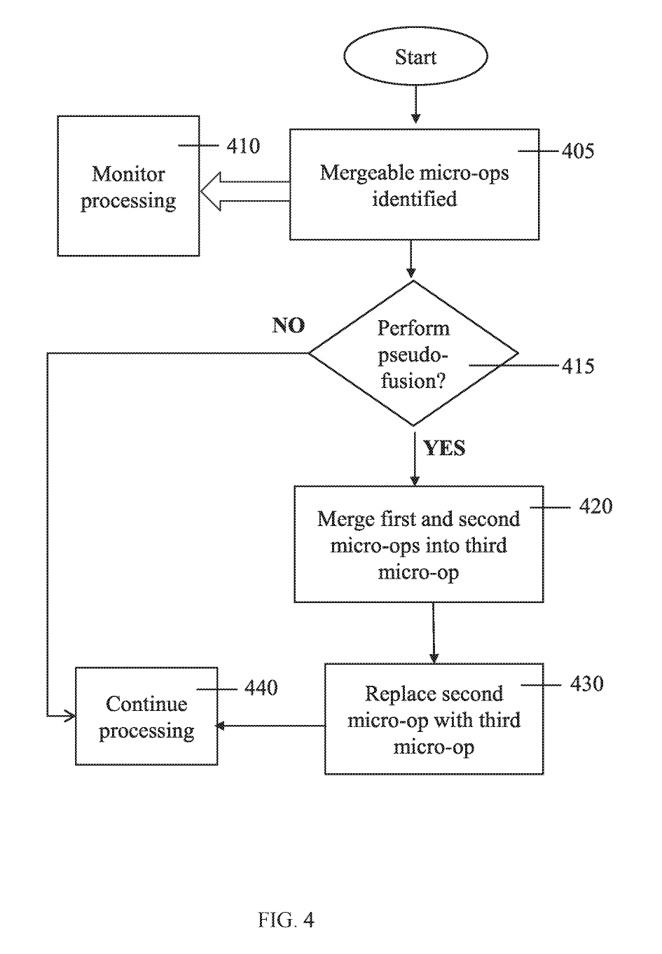

Reference is now made to FIG. 4, which is a simplified flowchart for a method of performing pseudo-fusion, according to embodiments of the invention. The method is performed by a hardware processor configured to execute program code. Optionally, the program code is stored on a non-transitory computer readable storage medium (e.g. external memory, processor internal memory, instruction cache and/or any other embodiment known in the art).

Optionally, the processor includes pseudo-fusion unit 182, which performs some or all of the method in cooperation with other units of the processor.

In 405 a mergeable pair of micro-operations is identified in a sequence of micro-operations of the program code. The pair of micro-operations includes a first micro-operation for performing a first function and a later non-consecutive second micro-operation for performing a second function. Optionally, the first micro-operation and the second micro-operation are fetched in different cycles.

Optionally, in 410 the processing is monitored over time and information is gathered and stored. Further optionally, this information is used to identify mergeable pairs of micro-ops in the instruction sequence as they are fetched and/or decoded.

In 415 the decision is made whether pseudo-fusion should be performed. If pseudo-fusion is not performed, processing continues in 440. If pseudo-fusion is performed, the micro-operations are merged. In 430, the merged micro-op replaces the second micro-op but the first micro-op is not dropped. Processing continues in 440. Optionally, the sequence is then dispatched.

Optionally, in some cases pseudo-fusion is prevented even when mergeable micro-ops are identified (for example after recovering from a mis-prediction).

### Monitoring Processing and Fusion Data

In some embodiments of up/down fusion and/or pseudo-fusion, data is collected and analyzed in order to decide whether and/or how fusion should be performed.

Optionally, processing of the program code is monitored over time. Micro-ops which satisfy the constraints required for merging are identified in repetitive program code and information about the mergeable pairs (denoted herein “fusion data”) is stored.

As used herein the term “repetitive program code” means any instruction sequence that is revisited and executed multiple times. For example, the repetitive sequence may comprise a loop, in which case the segments comprise multiple loop iterations, parts of an iteration or the continuation of a loop.

Optionally, the fusion data is analyzed for one or more of:
a) Identifying potentially-mergeable pairs as they are fetched and/or decoded;
b) Deciding whether to merge potentially-mergeable micro-ops (also denoted confirming the pair of micro-ops as mergeable);
c) Deciding whether to perform up/down fusion, pseudo-fusion or consecutive fusion;
d) Deciding whether to fuse-up or fuse-down; and
e) For recovery from a misprediction or interrupt.

Optionally, during subsequent processing, the fusion data is used to identify when a mergeable micro-op has been fetched and to identify other micro-op(s) with which it will be merged.

Optionally, the fusion data includes one or more of:
a) The program counter (PC) of at least one of the micro-ops;
b) The type of micro-op;
c) The micro-op operands; and
d) The distance between the micro-ops being merged.

Optionally, the fusion data is stored only after monitoring logic identifies that it is safe to merge the micro-ops.

The specific types of information stored as fusion data is implementation-based. In a simple example, the data structure stores the addresses or PC values of the pairs of micro-ops. Optionally, additional information is stored such as: the distance between the first and second micro-ops, the types of intermediate micro-ops, the occurrence of a branch between the first and second micro-operation, the likelihood of a misprediction, the merged micro-op and so forth.

Optionally, for both fuse-down and pseudo-fusion the fusion data includes the PC of the first micro-op and the PC (or distance) of the second micro-op.

Optionally, for fuse-up the fusion data includes the PC of the first micro-op, the PC (or distance) of the second micro-op and additional information about the second micro-op which is required in order to merge the first and second micro-ops (such as type of operation, operands, etc.).

Optionally, the fusion data includes the merged micro-op.

Reference is now made to FIG. 5, which is a simplified flowchart of a method for collecting and using fusion data, according to exemplary embodiments of the invention.

In 510, the processing of repetitive program code is monitored and a mergeable pair of micro-ops is identified in 520.

Optionally, data is collected while the processing is monitored. Optionally, the collected data is analyzed and/or preprocessed in order to prepare it for storage as fusion data. Further optionally the analysis includes, but is not limited to, one or more of:
a) Identifying potentially-mergeable micro-operations in the program code;
b) Determining whether the potentially-mergeable micro-operations should be merged (and, optionally, under what conditions);
c) Selecting the type of fusion which should be performed; and
d) Merging the mergeable micro-instructions.
   The analysis may be performed by any means known in the art (e.g. in accordance with specified logical rules).

In 530, fusion data about the identified mergeable pairs is stored.

In 540, monitoring and processing continues. When it is detected in 550 that the first micro-op of the pair has been fetched again (i.e. the code repeats), fusion data is retrieved for use during subsequent processing of the program code.

In one example, the data structure storing the fusion data is indexed by the PC of the first micro-op. When the first micro-op is fetched, the data structure is accessed and returns the PCs of all micro-ops with which the first micro-op may be merged.

In another scenario, branch or trace prediction may be used to predict whether the other mergeable micro-op(s) will be fetched. If the prediction is that all micro-ops participating in the merge will be fetched, fusion is performed. Otherwise, fusion is not performed.

Optionally, the method includes a recovery mechanism if the second micro-op does not appear.

Optionally, the fusion data collected during the monitoring is pre-analyzed information prior to being stored in order to facilitate use of the stored information when it is retrieved later.

In another exemplary embodiment, the fusion unit examines the instruction stream to find eligible candidates for up/down fusion and/or pseudo fusion. Every eligible candidate is marked/stored in a data structure, which may be a dedicated memory or an existing structure such as the instruction-cache or decoded micro-ops-cache. At this stage, up/down fusion or pseudo-fusion may or may not be performed. During instruction fetch, this data structure is searched (by PC or any other means) to identify if the fetched instructions are eligible candidates. If they are, the decoder performs the actual fusion.

### Multiple Pseudo-Fusions

In pseudo-fusion, the first micro-op may be pseudo-fused into more than one other micro-ops, as shown in Example 6:

Original code:
orr w5, w0, #0xf
add w10, w5, w6
and w11, w3, w5

The modified after multiple-pseudo-fusion is
orr w5, w0, #0xf
add w10, ORR(w0,#0xf), w6
and w11, w3, ORR(w0,#0xf)
   Fusion with Branch in Between

In some cases, an intermediate micro-op may be a conditional or unconditional branch instruction. Example 7 illustrates code which includes a conditional branch:
Original code:
0x100 orr w5, w0, #0xf
0x104 branch conditional 0x200
0x108 and w5, w5, w3
. . .
0x200 add w10, w5, w5

When fusing over a branch instruction the second micro-op may be only on one path of the branch. Optionally, processing of the merged micro-op is monitored and recovery mechanisms are implemented when the path not including the second micro-op is taken, as discussed in more detail below.

Optionally, branch prediction and/or trace prediction are used to predict whether a branch will be taken or not taken. The decision whether or not to merge the micro-ops is made based on the predicted result of the branch. In Example 7 above, the first micro-op is fused-down into the last micro-op correctly only if the branch is not taken. When the decoder encounters the ‘orr’ micro-op it may fuse-down only if the following branch is predicted to be “not taken”.

### Recovery Mechanisms

Optionally, the processor uses recovery mechanisms to recover from events such as mis-speculations and/or interrupts on the series of micro-ops starting at the first micro-op and ending at the second micro-op (inclusive). These mechanisms include but are not limited to:

a) For a mis-speculation (e.g. branch mis-prediction, or memory order violation) or flush event on an intermediate micro-op in the series, flush from the first micro-op (or before) and re-execute without merging. Using this mechanism requires committing the first micro-op only once the last micro-op is also ready to commit; and

b) For a mis-speculation event on one of the micro-ops in the series, flush at least all micro-ops after (and excluding) the micro-op which caused the mis-speculation (e.g. when a branch operation is mis-predicted, micro-ops after the branch are flushed).

During up/down fusion or pseudo-fusion it is possible to have a flush in one of the intermediate micro-ops (due to branch mis-prediction or another reason).

In pseudo-fusion, there is typically no need for special handling as the architectural state in the flushing micro-op is correct.

Optionally, in up/down fusion all micro-ops between first and second are committed or flushed.

Optionally, in up/down fusion the architectural state is recovered after a flush in an intermediate micro-op. In Example 7 above if the branch is predicted not-taken but resolved as taken, the value of w5 will not be correct (whether it was up-fusion or down-fusion) because the ‘orr’ micro-op was dropped or merged.

Solutions for recovering the architectural state include but are not limited to:

a) Flushing from the first micro-op rather than the flushing micro-op; and

b) Flushing from the flushing micro-op but inserting the dropped micro-ops prior to resuming fetch.

Interleaved pairs

Fusion and pseudo fusion may be interleaved, as illustrated by Example 8 which shows three interleaved fusions:

Original code:
and x0, x1, #0x7
orr x3, x1, #0xFF
sub x0, x0, #0x3
cmp x0, #0x4
b.1s 680
add x0, x3, x9

Code after fusion:
sub x0, AND(x1, #0x7), #0x3
cmp x0, #0x4
b.1s CMP(x0, #0x4), 680
add x0, ORR(x1, #0xFF), x9

In this example, ‘and’ is fused with ‘sub’, ‘orr’ is fused with ‘add’ and ‘cmp’ is fused with ‘b.1s’.

In some cases, pseudo-fusion may increase the probability of pairs for fusion as illustrated in Example 9 below:

Original code:
and w0, w1, #0x7
add w5, w0, w3
sub w0, w0, #0xf
   In this example, the ‘and’ and ‘sub’ micro-ops cannot be fused-down because w0 is read in between. However, if the ‘and’ and the ‘add’ are pseudo-fused, then it is possible to pseudo-fuse the ‘and’ and the ‘sub’ micro-ops.

The code after fusion:
add w5, AND(w1,#0x7), w3
sub w0, AND(w1,#0x7), #0xf

The above-described embodiments present beneficial techniques for up/down fusion and pseudo-fusion of micro-ops in an instruction sequence. The merged micro-op may be executed faster than executing the unmerged instructions. Dropping instructions during up/down fusion saves processor resources, such as dispatch and issuing slots, scheduler entries and physical register. Pseudo-fusion maintains the architectural state, simplifying handling when a flush occurs.

It is expected that during the life of a patent maturing from this application many relevant processors, pipelines, instructions, micro-operations, instruction processing, memories, program codes and techniques for merging instructions will be developed and the scope of the term processor, pipeline, instruction, micro-operation, processing, memory, program code and merging is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method comprising:
in a hardware processor configured to execute program code:
identifying, in a sequence of micro-operations of said program code, a mergeable pair of micro-operations, said pair of micro-operations comprising a first micro-operation for performing a first function and a second micro-operation for performing a second function, said first micro-operation preceding said second micro-operation in said sequence of micro-operations;
merging said first micro-operation into said second micro-operation to create a third micro-operation, wherein said third micro-operation performs both said first function and said second function; and
in said sequence of micro-operations, retaining said first micro-operation and replacing said second micro-operation with said third micro-operation.

2. A method according to claim 1, further comprising, after said replacing, dispatching said sequence of micro-operations.

3. A method according to claim 1, further comprising, when said first micro-operation and said second micro-operation are fetched, preventing said merging of said first micro-operation and said second micro-operation and dispatching said sequence of micro-operations in unmerged order.

4. A method according to claim 1, further comprising:
monitoring processing of said program code so as to identify said first micro-operation and said second micro-operation as mergeable into said third micro-operation for performing both said first function and said second function;
storing information indicating said first micro-operation and said second micro-operation as mergeable; and
upon a subsequent fetch of said first micro-operation, retrieving said stored information for use during subsequent processing of said program code.

5. A method according to claim 1, wherein said first micro-operation and said second micro-operation are non-consecutive in said sequence and micro-operations between said first micro-operation and said second micro-operation are retained in order in said sequence.

6. A method according to claim 1, further comprising, when an interrupt is detected during processing of a series of micro-operations, said series comprising said retained first micro-operation, said third micro-operation and intermediate micro-operations between said third micro-operation and said retained first micro-operation, flushing all micro-operations in said series preceding said interrupt and reprocessing with said second micro-operation unmerged.

7. A method according to claim 1, wherein said first micro-operation and said second micro-operation are non-consecutive in said sequence, further comprising:
detecting a mis-speculation event on an intermediate micro-operation between said third micro-operation and said retained first micro-operation; and
in response to said detecting said mis-speculation event, triggering recovery from said mis-speculation event.

8. A method according to claim 1, wherein said identifying comprises classifying said first micro-operation and said second micro-operation as a potentially-mergeable pair of micro-operations when a destination register of said first micro-operation comprises a source register of said second micro-operation.

9. A method according to claim 8, wherein said identifying further comprises confirming said potentially-mergeable pair of micro-operations as mergeable when one of:
said first micro-operation and said second micro-operation are consecutive in said sequence; and
said first micro-operation and said second micro-operation are non-consecutive in said sequence and all destination registers of micro-operations between said first micro-operation and said second micro-operation differ from the source registers of said first micro-operation.

10. A processor, comprising:
a hardware-implemented pipeline, configured to process program code; and
a pseudo-fusion unit associated with said pipeline, configured to:
identify, in a sequence of micro-operations processed in said pipeline, a mergeable pair of micro-operations, said pair of micro-operations comprising a first micro-operation for performing a first function and a second micro-operation for performing a second function, said first micro-operation preceding said second micro-operation in said sequence of micro-operations;
merging said first micro-operation into said second micro-operation to create a third micro-operation, wherein said third micro-operation performs both said first function and said second function; and
in said sequence of micro-operations, retaining said first micro-operation and replacing said second micro-operation with said third micro-operation.

11. A processor according to claim 10, wherein said identifying comprises detecting when a destination register of said first micro-operation comprises a source register of said second micro-operation.

12. A processor according to claim 11, wherein said first micro-operation and said second micro-operation are unmergeable when a destination register of a micro-operation between said first micro-operation and said second micro-operation is a source register of said first micro-operation.

13. A processor according to claim 10, wherein said pseudo-fusion unit is further configured to:
monitor processing of repetitive program code to detect that said first micro-operation and said second micro-operation are mergeable into said third micro-operation for performing both said first function and said second function;
store information relating to at least one of said first micro-operation and said second micro-operation; and
upon a subsequent fetch of said first micro-operation, retrieve said stored information for use during subsequent processing of said program code.

14. A processor according to claim 10, wherein said pseudo-fusion unit is further configured to dispatch said sequence after said replacing of said second micro-operation with said third micro-operation.

15. A processor according to claim 10, wherein said pseudo-fusion unit is further configured to prevent merging of said first micro-operation and said second micro-operation.

16. A processor according to claim 10, wherein said first micro-operation and said second micro-operation are non-consecutive and micro-operations between said first micro-operation and said second micro-operation are retained in order in said sequence.

17. A processor according to claim 10, further comprising an execution unit configured to execute said third micro-operation in a single cycle.

18. A processor according to claim 10, further comprising a memory storing said sequence of micro-operations in an issue queue, wherein said third micro-operation is stored in a single slot of said issue queue.

19. A processor according to claim 10, further configured to issue said first micro-operation and said third micro-operation concurrently for execution.

20. A processor according to claim 10, wherein said pseudo-fusion unit is further configured to monitor fetched micro-operations and to detect said first micro-operation and said second micro-operation prior to entry of said second micro-operation into a decoder unit of said processor.
